(19) United States
(12) Patent Application Publication
(10) Pub. No.: US 2026/0028190 A1
(43) Pub. Date: Jan. 29, 2026

(54) SUBSTRATE PROCESSING APPARATUS AND SUBSTRATE PROCESSING METHOD USING THE SAME

(71) Applicants: SAMSUNG DISPLAY CO., LTD., Yongin-si (KR); ULVAC, INC., Chigasaki-shi (JP)

(72) Inventors: KYUNGHOON CHUNG, Yongin-si (KR); MASAO NISHIGUCHI, Chigasaki-shi (JP); DAISUKE IWASE, Chigasaki-shi (JP); HYUNWOO CHO, Chigasaki-shi (JP); JUNGSEOB LEE, Yongin-si (KR); YONGSIC JEON, Yongin-si (KR); HYEONSIK KIM, Yongin-si (KR); YONG YEO, Yongin-si (KR)

(21) Appl. No.: 19/063,053

(22) Filed: Feb. 25, 2025

(30) Foreign Application Priority Data
Jul. 29, 2024 (KR) 10-2024-0100563

(51) Int. Cl. B65G 47/82; B65G 13/02

(52) U.S. Cl. CPC B65G 47/82; B65G 13/02

(57) ABSTRACT

A substrate processing apparatus and a substrate processing method are disclosed. A substrate processing method includes loading a substrate into a first load-lock chamber, loading the substrate and a carrier into a coupling chamber including a first transferer, seating the substrate on a first stage connected to the first transferer, transferring the carrier in a first direction using the first transferer and coupling the carrier with the substrate seated on the first stage concurrently, and unloading the substrate and the carrier from the coupling chamber.

### CROSS-REFERENCE TO RELATED APPLICATION

The present application claims priority to and the benefit of Korean Patent Application No. 10-2024-0100563, filed on Jul. 29, 2024 in the Korean Intellectual Property Office, the entire disclosure of which is incorporated herein by reference.

### BACKGROUND

### 1. Field

Aspects of embodiments of the present disclosure relate to a substrate processing apparatus and a substrate processing method using the same.

### 2. Description of the Related Art

When multiple processes are carried out in a vacuum state on multiple substrates, as a location change and movement path of a carrier that moves respective process chambers by mounting the substrates becomes more complex, a number of chambers in the process equipment increases and the process time increases.

As the manufacturing process becomes more complex, manufacturing time and manufacturing cost increase, and, accordingly, there is a need to reduce a residence time on a movement path of the substrate and the carrier. To avoid this problem, research is being conducted to shorten the time for the substrate and the carrier to be coupled and separated.

### SUMMARY

According to an aspect of embodiments of the present disclosure, a substrate processing apparatus used for coupling and separation of a substrate, and a substrate processing method using the same, are provided. According to another aspect of embodiments of the present disclosure, a substrate processing apparatus with reduced process time is provided.

According to another aspect of embodiments of the present disclosure, a substrate processing method using the substrate processing apparatus is provided.

A substrate processing method according to an embodiment of the present disclosure includes loading a substrate into a first load-lock chamber, loading the substrate and a carrier into a coupling chamber including a first transfer part, or first transferer, seating the substrate on a first stage connected to the first transfer part, transferring the carrier in a first direction using the first transfer part and coupling the carrier with the substrate seated on the first stage concurrently, or simultaneously, and unloading the substrate and the carrier from the coupling chamber.

In one or more embodiments, the method may further include, after seating the substrate on the first stage, rotating the first stage.

In one or more embodiments, in rotating the first stage, the first stage may be rotated such that an acute angle among inclination angles between a first base surface of a first base layer of the first stage and a first transfer surface of the first transfer part may be about 5 degrees to about 10 degrees.

In one or more embodiments, the method may further include, after rotating the first stage and before coupling the carrier with the substrate, transferring the substrate to a clamp portion of the carrier using a first grip portion, or first gripper, connected to the first stage.

In one or more embodiments, coupling the carrier with the substrate may be performed within about two minutes.

In one or more embodiments, in coupling the carrier with the substrate, the substrate may descend along a first rotating member of the first stage.

In one or more embodiments, the method may further include in loading the carrier into the coupling chamber, a seating surface of the carrier on which the substrate is seated may face a second direction intersecting the first direction.

In one or more embodiments, the method may further include, after loading the carrier into the coupling chamber, rotating the carrier such that the seating surface of the carrier faces a third direction intersecting the first direction and the second direction

In one or more embodiments, the method may further include, after unloading the substrate and the carrier from the coupling chamber, forming a film on the substrate using a plurality of process chambers.

In one or more embodiments, the method may further include, after forming the film on the substrate, loading the substrate and the carrier into a separation chamber including a second transfer part, or second transferer, seating an end of the substrate on a second stage connected to the second transfer part, transferring the carrier in a direction opposite to the first direction by the second transfer part, while concurrently, or simultaneously, separating the carrier from the substrate, and unloading the substrate and the carrier from the separation chamber.

In one or more embodiments, the method may further include, after seating the end of the substrate on the second stage connected to the second transfer part, seating a front surface of the substrate on the second stage using a second grip portion, or second gripper, connected to the second stage.

In one or more embodiments, in separating the substrate and the carrier, the substrate may move up along a second rotating member of the second stage.

In one or more embodiments, separating the substrate and the carrier may be performed within about 2 minutes.

In one or more embodiments, the method may further include after separating the substrate and the carrier and before unloading the substrate and the carrier from the separation chamber, rotating the second stage.

In one or more embodiments, in rotating the second stage, a second base surface of the second base layer of the second stage may be rotated to be parallel to a surface of a second transfer surface of the second transfer part.

In one or more embodiments, the method may further include, after separating the substrate and the carrier, rotating the carrier such that a seating surface of the carrier on which the substrate is seated faces a second direction intersecting the first direction.

In one or more embodiments, the lower insulating layer may include a same material as the insulating film.

According to one or more embodiments of the present disclosure, a substrate processing apparatus includes a first transfer part, or first transferer, arranged in a coupling chamber and configured to transfer a carrier in a first direction, a first stage connected to the first transfer part and rotatable around a rotation axis extending in a second direction intersecting the first direction, and a first grip portion, or first gripper, connected to the first stage and transferring the substrate in a same direction as the carrier.

In one or more embodiments, the first stage may include a base layer and a plurality of rotation members on the base layer.

In one or more embodiments, an acute angle among inclination angles formed between a base surface of the base layer and a transfer surface of the first transfer part may be about 5 degrees to about 10 degrees.

In one or more embodiments, a substrate processing apparatus may further include a second transfer part, or second transferer, arranged in a separation chamber spaced apart from the coupling chamber and transferring a carrier, a second stage connected to the second transfer part and having an inclination angle with a surface of the second transfer part, and a second grip portion, or second gripper, connected to the second stage and configured to transfer the substrate in a same direction as the carrier.

A substrate processing method according to one or more embodiments of the present disclosure may include loading a substrate into a first load-lock chamber, loading the substrate and a carrier into a coupling chamber including a first transfer part, seating the substrate on a first stage connected to the first transfer part, transferring the carrier in a first direction using the first transfer part and coupling the carrier with the substrate seated on the first stage concurrently, or simultaneously, and unloading the substrate and the carrier from the coupling chamber.

In addition, the substrate processing method may include loading the substrate and the carrier into the separation chamber including the second transfer part, seating one end of the substrate on a second stage connected to the second transfer part, transferring the carrier in a direction opposite to the first direction by the second transfer part, while concurrently, or simultaneously, separating the carrier from the substrate, and unloading the substrate and the carrier from the separation chamber.

Accordingly, a residence time of the substrate and the carrier in the coupling chamber may be reduced by coupling the carrier with the substrate while moving. In addition, as the carrier moves and is separated from the substrate, a separation time of the substrate and the carrier in the separation chamber may also be reduced, thereby increasing an overall process efficiency of the substrate processing apparatus.

### BRIEF DESCRIPTION OF THE DRAWINGS

The accompanying drawings, which are included to provide a further understanding of the inventive concept and are incorporated in and constitute a part of this specification, illustrate some example embodiments of the inventive concept together with the description.

FIG. 1 is a schematic view showing a substrate processing apparatus according to an embodiment of the present disclosure.

FIG. 2 is enlarged perspective view of a region “A” of a coupling chamber of FIG. 1.

FIG. 3 is an enlarged perspective view of a region “B” of a separation chamber of FIG. 1.

FIG. 4 is a cross-sectional view showing carrier rotating in a (1-1)th area of FIG. 2.

FIGS. 5 and 6 are cross-sectional views showing a first stage and a first transfer part of FIG. 2.

FIG. 7 is a flowchart showing a substrate processing method using the substrate processing apparatus of FIG. 1.

FIG. 8 is a flowchart showing coupling the substrate and the carrier of FIG. 7.

FIGS. 9 to 12 are perspective views showing an embodiment of the coupling of the substrate and the carrier in the coupling chamber of FIG. 2.

FIG. 13 is a flowchart showing separating the carrier and the substrate of FIG. 7.

FIGS. 14 to 17 are perspective views showing an embodiment of separating the substrate and the carrier in the separation chamber of FIG. 3.

### DETAILED DESCRIPTION

Regarding embodiments of the present disclosure disclosed in this text, specific structural and functional descriptions are provided as illustrative for a purpose of explaining the embodiments of the present disclosure, and the embodiments of the present disclosure may be implemented in various forms and are not to be construed as limited to the example embodiments described herein.

Since the present disclosure may be subject to various changes and may have various forms, some example embodiments will be illustrated in the drawings and described in further detail in the text. However, this is not intended to limit the present disclosure to a specific disclosed form, and it is to be understood to include all changes, equivalents, and substitutes included in the spirit and technical scope of the present disclosure.

Terms such as “first,” “second,” etc. may be used to describe various components, but the components are not to be limited by the terms. The above terms may be used for a purpose of distinguishing one component from another component. For example, a first component may be referred to as a second component, and similarly, the second component may be referred to as a first component without departing from the scope of the present disclosure.

It is to be understood that when an element is referred to as being “connected” or “coupled” to another element, it may be directly connected or coupled to the other element or one or more intervening elements may be present. In contrast, when an element is referred to as being “directly connected” or “directly coupled” to another element, there are no intervening elements present. Other words used to describe the relationship between elements are to be interpreted in a like fashion (e.g., “between” versus “directly between,” “adjacent” versus “directly adjacent,” etc.).

The terminology used herein is provided for describing particular example embodiments and is not intended to be limiting of the present inventive concept. As used herein, the singular forms “a,” “an,” and “the” are intended to include plural forms as well, unless the context clearly indicates otherwise. It is to be further understood that the terms “comprises” and/or “comprising,” when used in this specification, specify a presence of stated features, integers, steps, operations, elements, and/or components, but do not preclude the presence or addition of one or more other features, integers, steps, operations, elements, components, and/or groups thereof.

Terms such as “below,” “at the bottom,” “lower,” “below,” “above,” “on top,” “on the top,” “on,” etc. are used to explain a relationship between components shown in the drawings. The terms are relative concepts and are explained based on the direction indicated in the drawings.

Unless otherwise defined, all terms (including technical and scientific terms) used herein have a same meaning as commonly understood by one of ordinary skill in the art to which this inventive concept belongs. It is to be further understood that terms, such as those defined in commonly used dictionaries, are to be interpreted as having a meaning that is consistent with their meaning in the context of the relevant art and are not to be interpreted in an idealized or overly formal sense unless expressly so defined herein.

Herein, some embodiments will be described in further detail with reference to the accompanying drawings. Same reference numerals are used for same components in the drawings, and redundant descriptions of same components may be omitted.

In this specification, a plane may be defined by a first direction D1 and a second direction D2 that intersects the first direction D1. For example, the second direction D2 may be perpendicular to the first direction D1. In addition, a third direction D3 may be a normal direction of the plane. That is, the third direction D3 may be perpendicular to the plane formed by the first direction D1 and the second direction D2.

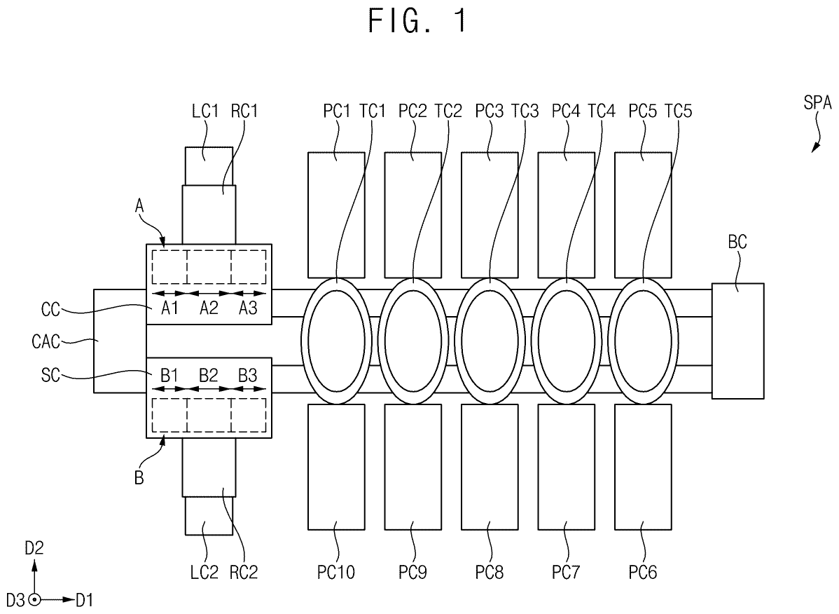

FIG. 1 is a schematic view showing a substrate processing apparatus according to an embodiment of the present disclosure.

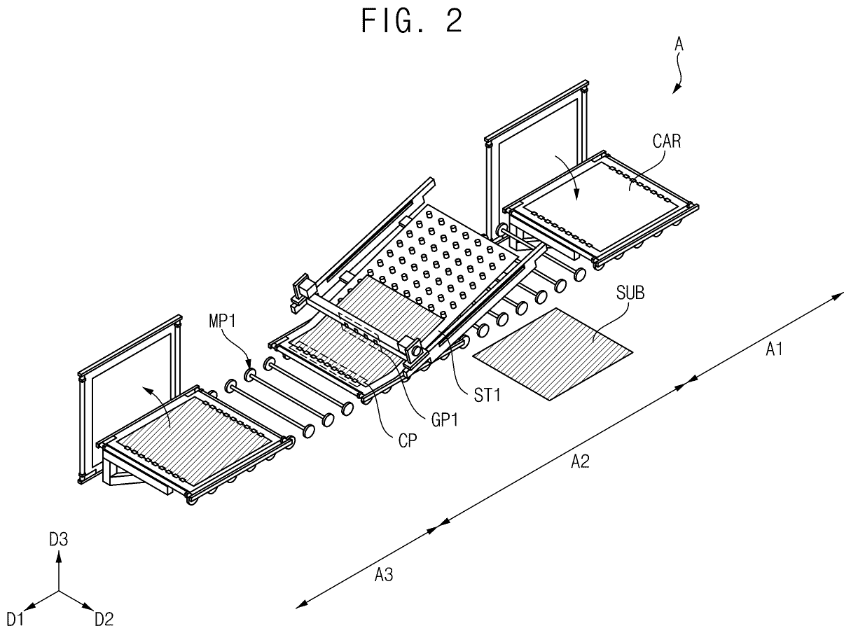

Referring to FIGS. 1 and 2, a substrate processing apparatus SPA may include first and second load-lock chambers LC1, LC2, first and second robot chambers RC1, RC2, coupling chamber CC, separation chamber SC, carrier storage chamber CAC, first, second, third, fourth, and fifth transfer chambers TC1, TC2, TC3, TC4, and TC5, first, second, third, fourth, fifth, sixth, seventh, eighth, ninth, and tenth process chambers PC1, PC2, PC3, PC4, PC5, PC6, PC7, PC8, PC9, and PC10, and a turnback chamber BC.

A substrate SUB may be brought into the substrate processing apparatus SPA by the first load-lock chamber LC1. After the substrate SUB is brought into the first load-lock chamber LC1, the first load-lock chamber LC1 may exhaust air existing inside. Accordingly, an interior of the first load-lock chamber LC1 may be kept close to a vacuum with minimal residual air. For example, an air pressure in the first load-lock chamber LC1 may be about 50 m Torr or less. However, embodiments of the present disclosure are not necessarily limited thereto.

The first robot chamber RC1 may be connected to the first load-lock chamber LC1. The first robot chamber RC1 may include first robots transferring the substrate SUB. The first robots disposed in the first robot chamber RC1 may transfer the substrate SUB to the coupling chamber CC. That is, the first robots disposed in the first robot chamber RC1 may transfer the substrate SUB brought through the first load lock chamber LC1 to the coupling chamber CC.

The coupling chamber CC may be connected to the first robot chamber RC1. The coupling chamber CC may be a chamber in which the substrate SUB and a carrier CAR are coupled. That is, the substrate SUB brought in through the first load-lock chamber LC1 and the carrier CAR brought in from the carrier storage chamber CAC may be coupled in the coupling chamber CC. The coupling chamber CC may be described in further detail in with reference to FIG. 2.

The first, second, third, fourth, fifth, sixth, seventh, eighth, ninth, and tenth process chambers PC1, PC2, PC3, PC4, PC5, PC6, PC7, PC8, PC9, and PC10 may be chambers performing a film forming process on the substrate SUB. A film process may be performed to the substrate SUB by the first to fifth process chambers PC1, PC2, PC3, PC4, and PC5 and then rotated by the turnback chamber BC. Thereafter, an additional film process may be performed through the sixth, seventh, eighth, ninth, and tenth process chambers PC6, PC7, PC8, PC9, and PC10 on the substrate SUB rotated in the turnback chamber BC.

For example, each of the first, second, third, fourth, fifth, sixth, seventh, eighth, ninth, and tenth process chambers PC1, PC2, PC3, PC4, PC5, PC6, PC7, PC8, PC9, and PC10 may include a deposition chamber, an etching chamber, a development chamber, an exposure chamber, etc. However, embodiments of the present disclosure are not necessarily limited thereto. In FIG. 1, the substrate processing apparatus SPA is shown to include ten process chambers, but the substrate processing apparatus SPA may include nine or less chambers, or eleven or more chambers.

The first, second, third, fourth, and fifth transfer chambers TC1, TC2, TC3, TC4, and TC5 may be connected to each other in the first direction D1. In an embodiment, the first transfer chamber TC1 may be connected to the coupling chamber CC and the second transfer chamber TC2. The second transfer chamber TC2 may be connected to the first transfer chamber TC1 and the third transfer chamber TC3. The third transfer chamber TC3 may be connected with the second transfer chamber TC2 and the fourth transfer chamber TC4. The fourth transfer chamber TC4 may be connected with the third transfer chamber TC3 and the fifth transfer chamber TC5. The fifth transfer chamber TC5 may be connected with the fourth transfer chamber TC4 and the turnback chamber BC.

In addition, as shown in FIG. 1, the first transfer chamber TC1 may be connected to the first process chamber PC1 and the tenth process chamber PC10. The second transfer chamber TC2 may be connected to the second process chamber PC2 and the ninth process chamber PC9. The third transfer chamber TC3 may be connected to the third process chamber PC3 and the eighth process chamber PC8. The fourth transfer chamber TC4 may be connected to the fourth process chamber PC4 and the seventh process chamber PC7. The fifth transfer chamber TC5 may be connected with the fifth process chamber PC5 and the sixth process chamber PC6.

Each of the first, second, third, fourth, and fifth transfer chambers TC1, TC2, TC3, TC4, and TC5 may transfer the substrate SUB. The first, second, third, fourth, and fifth transfer chambers TC1, TC2, TC3, TC4, and TC5 may transfer the substrate SUB taken out of the coupling chamber CC to the first, second, third, fourth, fifth, sixth, seventh, eighth, ninth, and tenth process chambers PC1, PC2, PC3, PC4, PC5, PC6, PC7, PC8, PC9, and PC10.

The separation chamber SC may be connected to the first transfer chamber TC1. The separation chamber SC may be a place where the substrate SUB and the carrier CAR, which have completed the film forming process and are brought in through the first transfer chamber TC1, are separated from each other. The substrate SUB separated from the carrier CAR in the separation chamber SC may be brought into the second load-lock chamber LC2, and the carrier CAR may be brought into the carrier storage chamber CAC.

The second robot chamber RC2 may be connected to the separation chamber SC. The second robot chamber RC2 may include second robots that transfer the substrate SUB. The second robots disposed in the second robot chamber RC2 may transfer the substrate SUB to the second load-lock chamber LC2. In other words, the second robots disposed in the second robot chamber RC2 may transfer the substrate SUB brought in through the separation chamber SC to the second load-lock chamber LC2.

The second load-lock chamber LC2 may be a passage through which the substrate SUB is taken out of the substrate processing apparatus SPA. After the substrate SUB is brought into the second load-lock chamber LC2, the second load-lock chamber LC2 may introduce air substantially equal to an atmospheric pressure outside the substrate processing apparatus SPA. Accordingly, the second load-lock chamber LC2 may be capable of maintaining a pressure substantially equal to atmospheric pressure.

FIG. 2 is enlarged perspective view of a region “A” of the coupling chamber of FIG. 1.

Referring to FIGS. 1 and 2, the coupling chamber CC may include a first transfer part, or first transferer, MP1 and a first stage ST1.

The first transfer part MP1 may transfer the carrier CAR. The first transfer part MP1 may transfer the carrier CAR in the first direction D1. That is, the carrier CAR brought into the coupling chamber CC may be seated in the first transfer part MP1 and sequentially transferred along a (1-1)th area A1, a (1-2)th area A2, and a (1-3)th area A3. In FIG. 2, the first transfer part MP1 is shown in the form of a roller, but the present disclosure is not limited thereto, and the first transfer part MP1 may include a conveyor belt, etc.

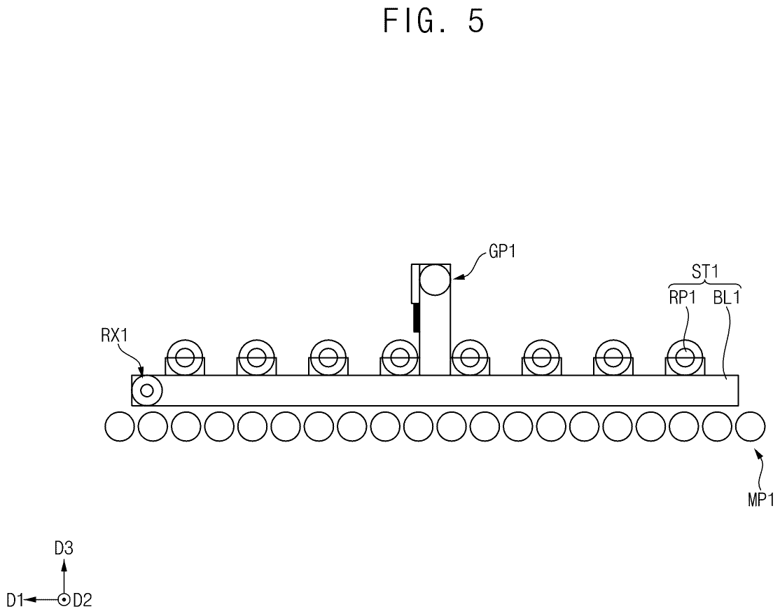

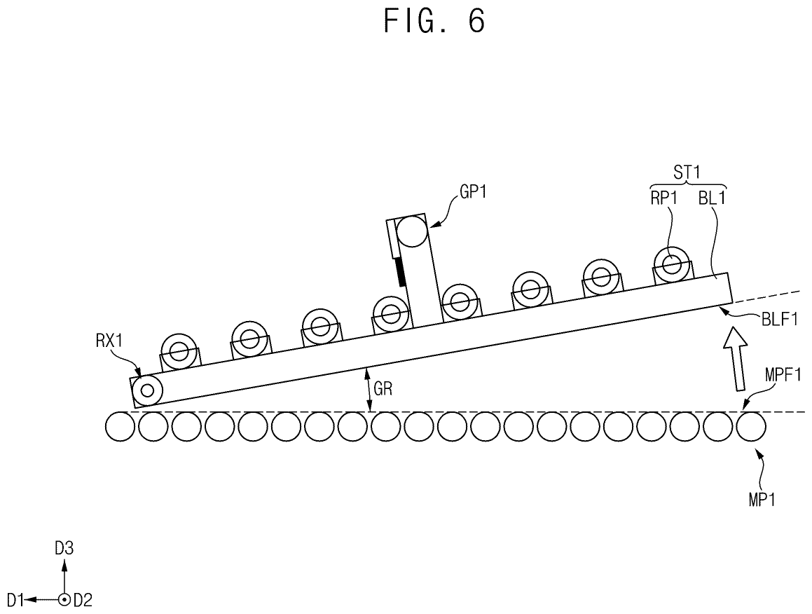

The first stage ST1 may be connected to the first transfer part MP1. The first stage ST1 may be connected to a part of the first transfer part MP1 and may be disposed in a fixed position. The substrate SUB brought into the coupling chamber CC may be seated on the first stage ST1. The first stage ST1 may rotate around a first rotation axis (e.g., the first rotation axis RX1 of FIG. 5). A shape and function of the first stage ST1 will be described further later with reference to FIGS. 5 and 6.

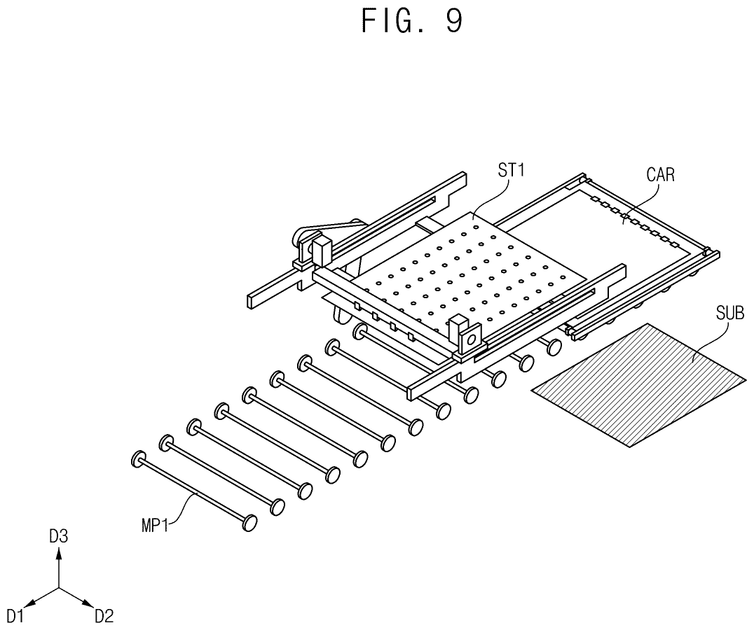

The substrate SUB seated on the first stage ST1 may descend the first stage ST1 and may be coupled with the carrier CAR that passes under the first stage ST1. The substrate SUB may be coupled to a clamp portion CP of the carrier CAR through a first grip portion, or first gripper, GP1 connected to the first stage ST1. A method of coupling the substrate SUB and the carrier CAR will be described further later with reference to FIGS. 9, 10, 11, and 12.

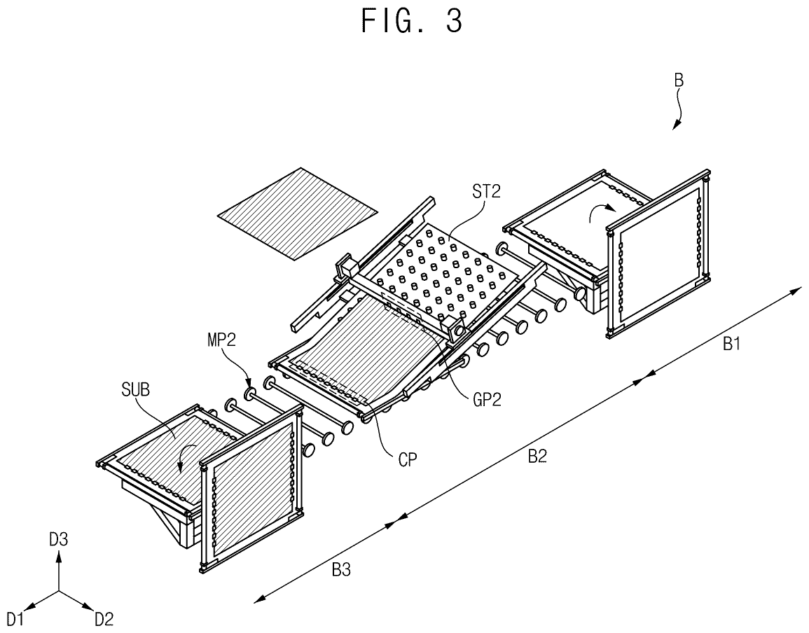

FIG. 3 is an enlarged perspective view of a region “B” of the separation chamber of FIG. 1.

Referring to FIGS. 1, 2, and 3, the separation chamber SC may include a second transfer part, or second transferer, MP2 and a second stage ST2. The second transfer part MP2 and the second stage ST2 shown in FIG. 3 may have same or substantially the same functions and layout as the first transfer part MP1 and the first stage ST1 of FIG. 2. Therefore, overlapping description may be omitted or simplified.

The second transfer part MP2 may transfer the carrier CAR. The second transfer part MP2 may transfer the carrier CAR in a direction opposite to the first direction D1. That is, the carrier CAR brought into the separation chamber SC may be seated in the second transfer part MP2 and transferred in a direction opposite to the first direction D1 along a (2-3)th area B3, a (2-2)th area B2, and a (2-1)th area B1. In FIG. 3, the second transfer part MP2 is shown in the form of a roller, but the present disclosure is not limited thereto, and the second transfer part MP2 may include a conveyor belt, etc.

The second stage ST2 may be connected to the second transfer part MP2. The second stage ST2 may be connected to a part of the second transfer part MP2 and may be disposed in a fixed position. The substrate SUB brought into the separation chamber SC may be seated on the second stage ST2.

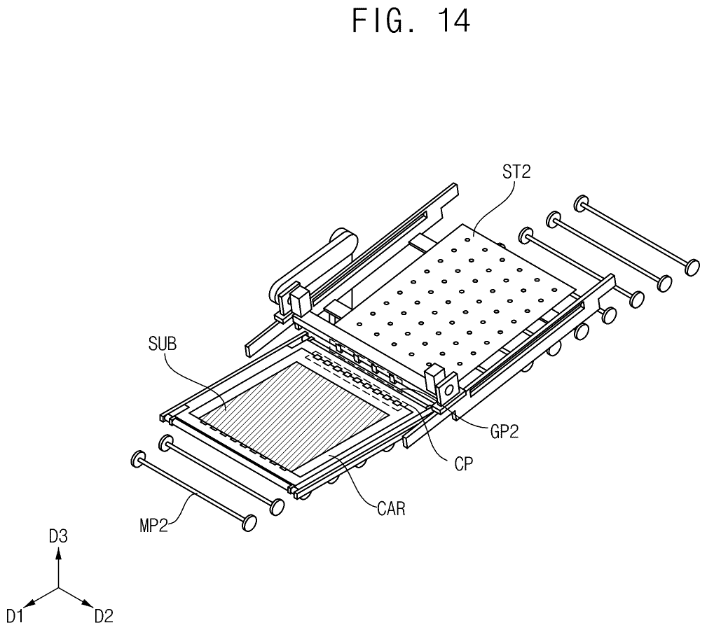

The substrate SUB seated on the second stage ST2 may move up the second stage ST2 and may be separated from the carrier CAR that passes under the second stage ST2. The substrate SUB may be separated from the carrier CAR through the second grip portion GP2 connected to the second stage ST2. A method of separating the substrate SUB and the carrier CAR will be described later with reference to FIGS. 14, 15, 16, and 17.

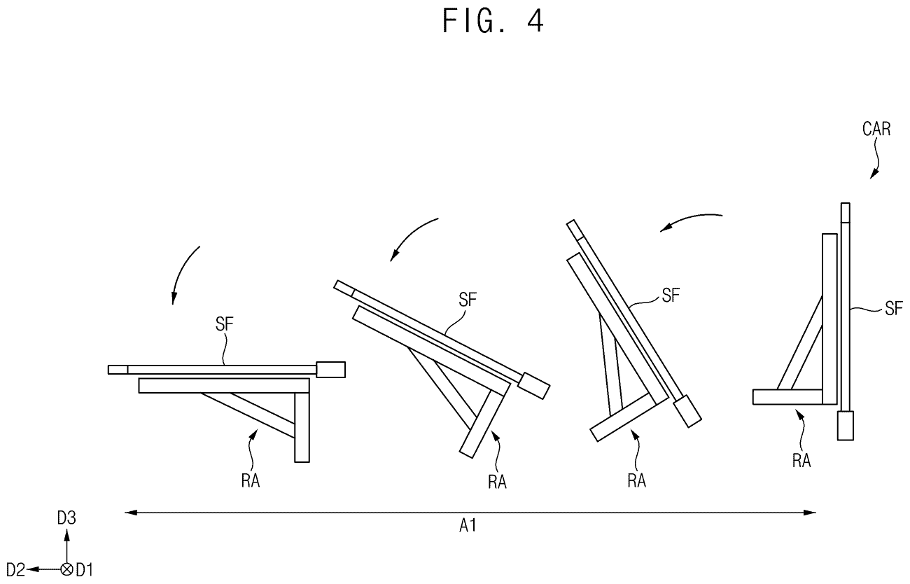

FIG. 4 is a cross-sectional view showing a carrier rotating in the (1-1)th area A1 of FIG. 2.

Referring to FIGS. 1, 2, 3, and 4, the carrier CAR may have a seating surface SF. The seating surface SF of the carrier CAR may have an area greater than an area of the substrate SUB such that the carrier CAR may be coupled with the substrate SUB. The substrate SUB may be coupled to the seating surface SF of the carrier CAR and transferred in the substrate processing apparatus SPA.

In an embodiment, as shown in FIGS. 2 and 4, the carrier CAR may rotate around a virtual first rotation axis extending in the first direction D1 in the coupling chamber CC. The carrier CAR may rotate around the virtual first rotation axis extending in the first direction D1 by a rotary apparatus RA disposed in the coupling chamber CC. The carrier CAR may be rotated and seated on the first transfer part MP1 as shown in FIG. 2.

In an embodiment, as shown in FIGS. 3 and 4, the carrier CAR may rotate around a virtual second rotation axis within the separation chamber SC. The carrier CAR may rotate around the virtual second rotation axis extending in the first direction D1. The carrier CAR may be rotated as shown in FIG. 3 and seated on the second transfer part MP2.

FIGS. 5 and 6 are cross-sectional views showing the first stage and the first transfer part of FIG. 2. FIGS. 5 and 6 are described with reference to the first stage ST1, but the second stage ST2 of FIG. 3 may have substantially a same form and function as the first stage ST1. Therefore, overlapping description may be omitted or simplified.

Referring to FIGS. 2, 5, and 6, the first stage ST1 may include a first base layer BL1, a first rotating member RP1, and the first grip portion GP1.

The first base layer BL1 may support the substrate SUB brought into the coupling chamber CC.

The first rotation axis RX1 extending in the second direction D2 may be disposed at an end of the first base layer BL1. For example, the first stage ST1 may rotate around the first rotation axis RX1. As the first stage ST1 rotates around the first rotation axis RX1, a first base surface BLF1, which is a bottom surface of the first base layer BL1, and a first transfer surface MPF1 which is a top surface of the first transfer part MP1 may have an inclination angle GR in a cross-sectional view.

In an embodiment, an acute angle of the inclination angle GR formed by the first base surface BLF1 of the first base layer BL1 and the first transfer surface MPF1 of the first transfer part MP1 may be 10 degrees or less. In an embodiment, an acute angle of the inclination angle GR formed by the first base surface BLF1 of the first base layer BL1 and the first transfer surface MPF1 of the first transfer part MP1 may be about 5 degrees or more and 10 degrees or less. If an acute angle among the inclination angles GR is less than about 5 degrees, a descending speed of the substrate SUB seated on the first stage ST1 may be slow, and if an acute angle among the inclination angles GR is greater than about 10 degrees, a speed at which the substrate SUB descends may increase, which may cause damage to the substrate SUB.

A plurality of the first rotating member RP1 may be disposed on the first base layer BL1. In an embodiment, the first rotating member RP1 may be disposed in a form of a mattress in the first direction D1 and the second direction D2. Due to an arrangement of the first rotating member RP1, the substrate SUB seated on the first stage ST1 may descend along the first base layer BL1.

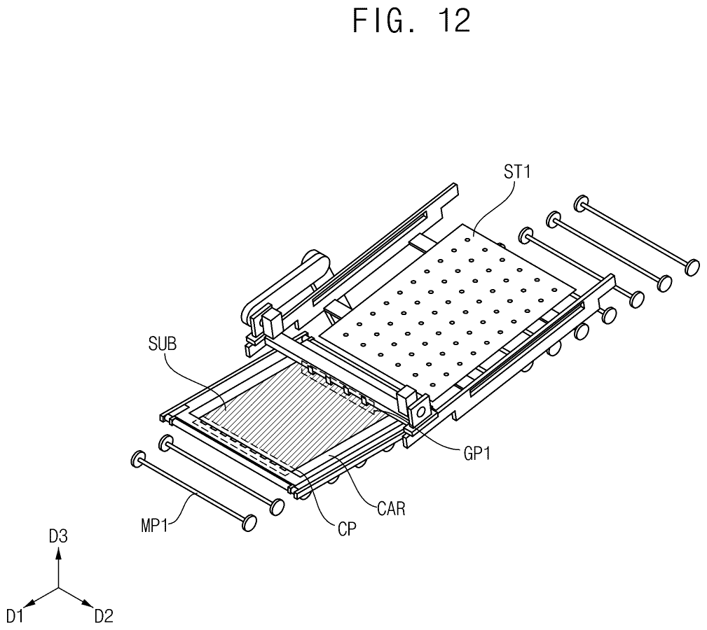

The first grip portion GP1 may be connected to the first base layer BL1. The first grip portion GP1 may grasp the substrate SUB seated on the first base layer BL1. In an embodiment, the first grip portion GP1 may grasp the substrate SUB and pull the substrate SUB down in the first base layer BL1 of the first stage ST1. An embodiment in which the first grip portion GP1 pulls down the substrate SUB will be described later with reference to FIGS. 9 and 12.

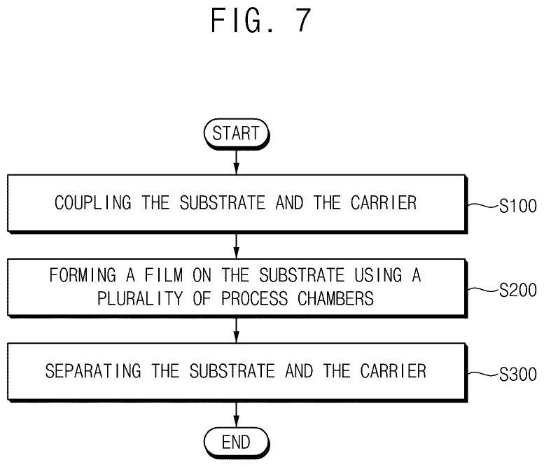

As described with reference to FIGS. 5 and 6, the second stage ST2 of FIG. 3 may include a second base layer, a second rotation member, and the second grip portion GP2. Additionally, the second stage ST2 may include a second rotation axis extending in the second direction D2 and may rotate around the second rotation axis. FIG. 7 is a flowchart showing a substrate processing method using the substrate processing apparatus of FIG. 1.

Referring to FIGS. 1 and 7, the substrate SUB and the carrier CAR may be coupled in the coupling chamber CC (S100). After the substrate SUB is coupled to the carrier CAR, the filming process may be performed to the substrate SUB using the first, second, third, fourth, fifth, sixth, seventh, eighth, ninth, and tenth process chambers PC1, PC2, PC3, PC4, PC5, PC6, PC7, PC8, PC9, and PC10 (S200). After completing the filming process on the substrate SUB, the substrate SUB and the carrier CAR may be separated in the separation chamber SC (S300).

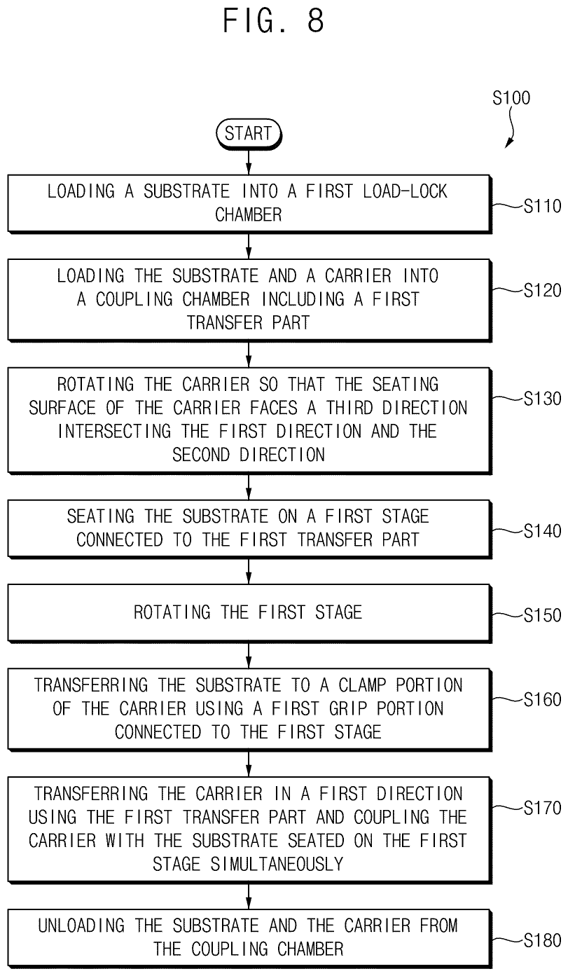

FIG. 8 is a flowchart showing coupling the substrate and carrier of FIG. 7; and FIGS. 9 to 12 are perspective views showing the coupling of substrate and carrier in the coupling chamber of FIG. 2 according to an embodiment.

Referring to FIGS. 1, 7, and 8, the substrate SUB may be brought into the substrate processing apparatus SPA through the first load-lock chamber LC1 (S110). The substrate SUB brought into the first load-lock chamber LC1 may be brought into the coupling chamber CC including the first transfer part MP1 by passing through the first robot chamber RC1. In addition, the carrier CAR stored in the carrier storage chamber CAC may also be brought into the coupling chamber CC (S120).

The carrier CAR brought into the coupling chamber CC may face a direction opposite to the second direction D2. Thereafter, the carrier CAR may be rotated around the first rotation axis (e.g., the first rotation axis RX1 of FIG. 5) to face the third direction D3 by the rotary apparatus (e.g., the rotary apparatus RA of FIG. 4) to be coupled with the substrate SUB (S130).

In an embodiment, the seating surface SF of the carrier CAR shown in FIG. 4 may face a direction opposite to the second direction D2. That is, the seating surface SF of the carrier CAR may be brought into the bonding chamber CC while facing a direction opposite to the second direction D2 in the (1-1)th area A1. Thereafter, the seating surface SF may rotate around the first rotation axis RX1 to face the third direction D3. As the seating surface SF of the carrier CAR moves in the carrier storage chamber CAC while facing a direction opposite to the second direction D2, a planar area of the substrate processing apparatus SPA may be reduced. However, the carrier CAR may not rotate. The seating surface SF of the carrier CAR may also be transferred while facing the third direction D3 when being transferred in the carrier storage chamber CAC.

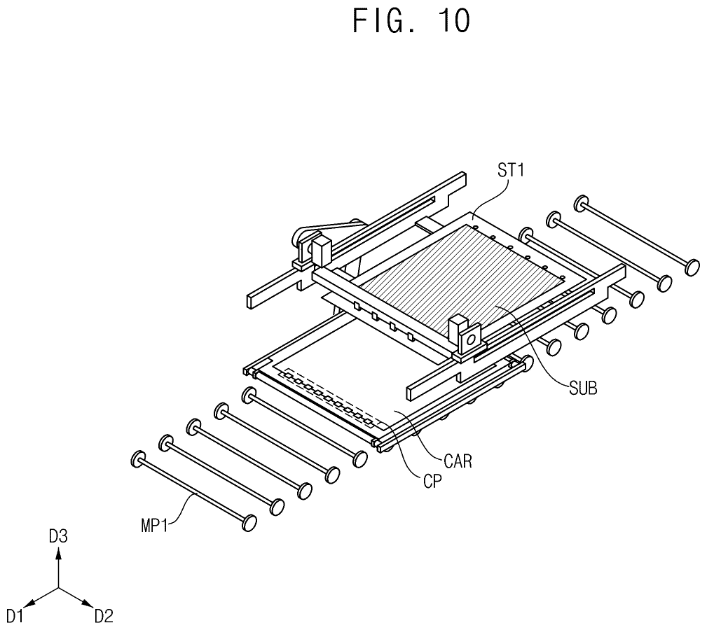

Referring further to FIGS. 9 and 10, the substrate SUB brought into the coupling chamber CC may be transferred in a direction opposite to the second direction D2 and seated on the first stage ST1 (S140).

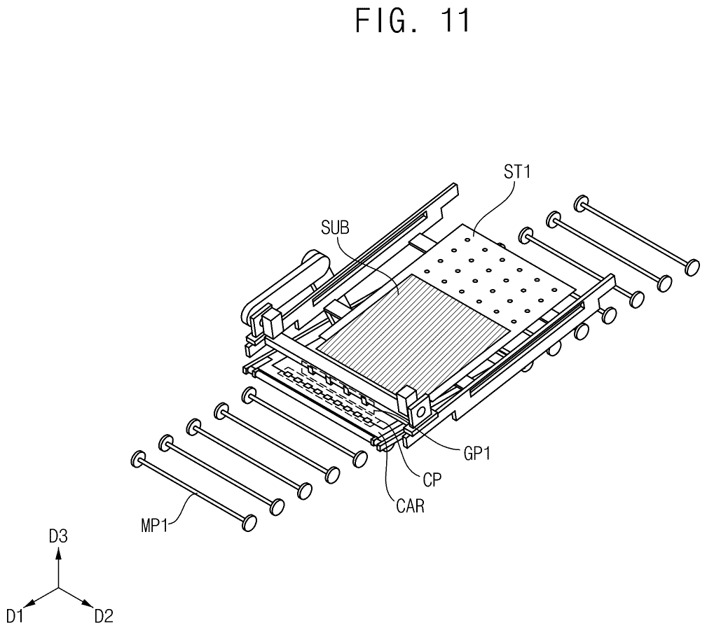

Referring further to FIGS. 6 and 11, the first stage ST1 may be rotated after the substrate SUB is seated (S150). The first stage ST1 may be rotated around the first rotation axis of rotation RX1 of the first base layer BL1. Accordingly, the first base surface BLF1 of the first base layer BL1 and the first transfer surface MPF1 of the first transfer part MP1 may have the inclination angle GR. Thereafter, the first grip portion GP1 connected to the first stage ST1 may grasp the substrate SUB and transfer the substrate SUB to the clamp portion CP of the carrier CAR (S160).

Referring further to FIGS. 6 and 12, the substrate fixed to the clamp portion CP may descend in the first rotating member RP1 of the first stage ST1. The substrate SUB may descend the first stage ST1, and, at a same time, the carrier CAR may move in the first direction D1. Accordingly, the substrate SUB may be coupled with the carrier CAR while descending the first stage ST1 (S170).

After the substrate SUB and the carrier CAR have been coupled, the substrate SUB and the carrier CAR may be taken out of the coupling chamber (e.g., the coupling chamber CC of FIG. 1) (S180). Thereafter, the filming process may be performed through the first, second, third, fourth, fifth, sixth, seventh, eighth, ninth, and tenth process chambers PC1, PC2, PC3, PC4, PC5, PC6, PC7, PC8, PC9, and PC10 on the substrate SUB (S200).

In an embodiment, coupling the substrate SUB and the carrier CAR may be performed in about two minutes or less. In an embodiment, coupling the substrate SUB and the carrier CAR may be performed in about one minute or less. By ensuring that a time required for a coupling the substrate SUB and the carrier CAR satisfies the above-described range, a process efficiency of the substrate processing apparatus SPA may be increased.

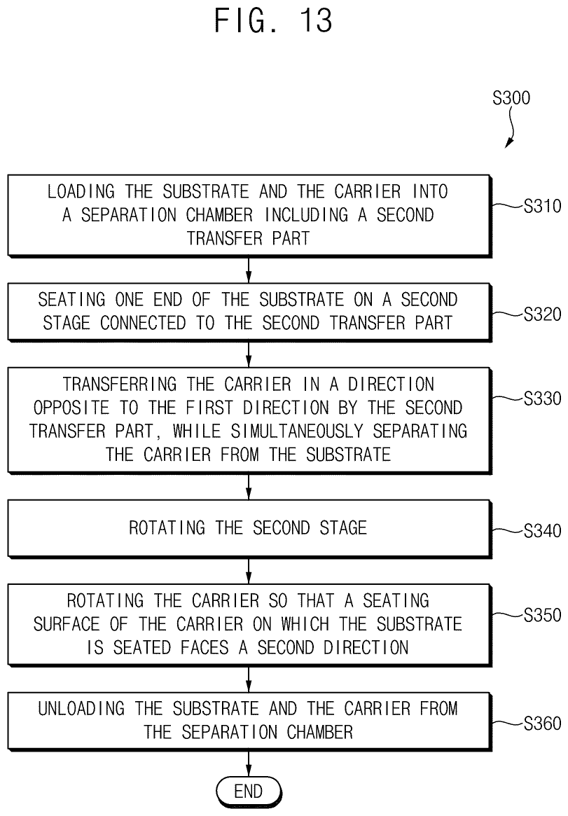

FIG. 13 is a flowchart showing separating the carrier and the substrate of FIG. 7. FIGS. 14 to 17 are perspective views showing an embodiment of separating the substrate and carrier in the separation chamber of FIG. 3.

Referring to FIGS. 1, 3, 13, and 14, the substrate SUB that has completed the filming process may be brought into the separation chamber SC (S310). The substrate SUB and the carrier CAR may be transferred to the second stage ST2 by the second transfer part MP2 in the separation chamber SC.

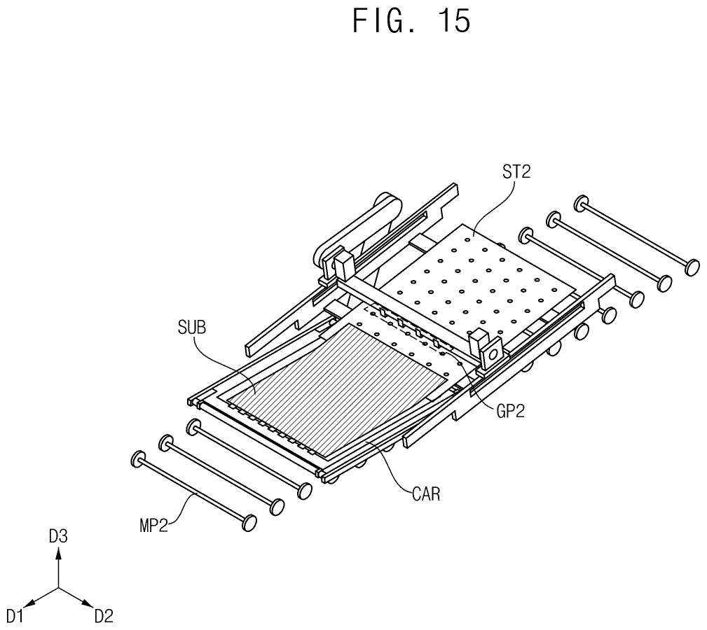

Referring further to FIG. 15, an end of the substrate transferred to the second stage ST2 may be seated on the second stage ST2 (S320). Thereafter, an end of the substrate SUB may be grasped by the second grip portion GP2 of the second stage ST2 and a surface of the substrate SUB may be seated on the second stage ST2. As the substrate SUB is seated on the second stage ST2 and the carrier CAR moves in a direction opposite to the first direction D1, the substrate SUB and the carrier CAR may be separated (S330). The substrate SUB may move up in the second rotating member of the second stage ST2.

In an embodiment, separation the substrate SUB and the carrier CAR may be performed in about 2 minutes or less. In an embodiment, separation of the substrate SUB and the carrier CAR may be performed in about 1 minute or less. By ensuring that a time required for a separation of the substrate SUB and the carrier CAR satisfies the above-described range, a process efficiency of the substrate processing apparatus SPA may be increased.

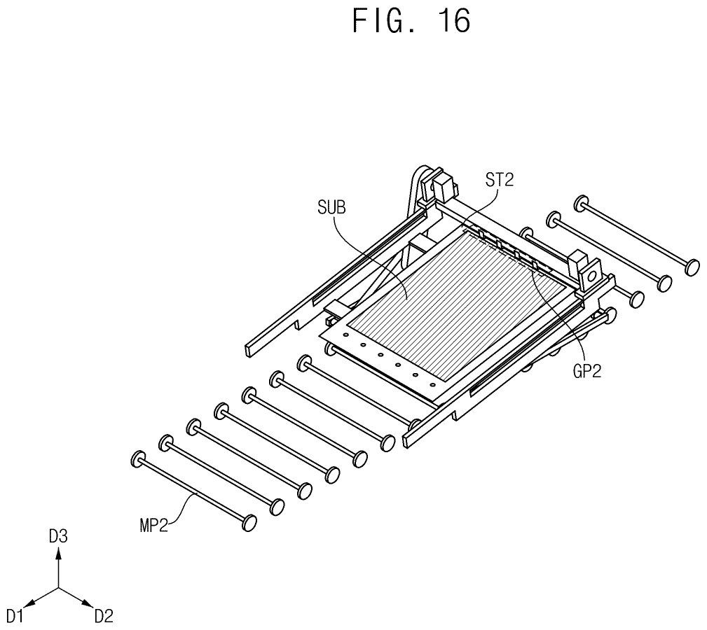

Referring further to FIGS. 6 and 16, after the substrate and the carrier CAR have been separated, the second stage ST2 may be rotated (S340). The second stage ST2 may rotate around the second rotation axis of rotation. Accordingly, a second base surface of the second base layer of the second stage ST2 may be parallel to a second transfer surface of the second transfer part MP2.

Thereafter, the carrier CAR may rotate around the second rotation axis in the (2-1)th area B1, as shown in FIGS. 3 and 4. Specifically, after the carrier CAR faces the third direction D3, the carrier CAR may rotate around the second rotation axis to face the second direction D2 (S350).

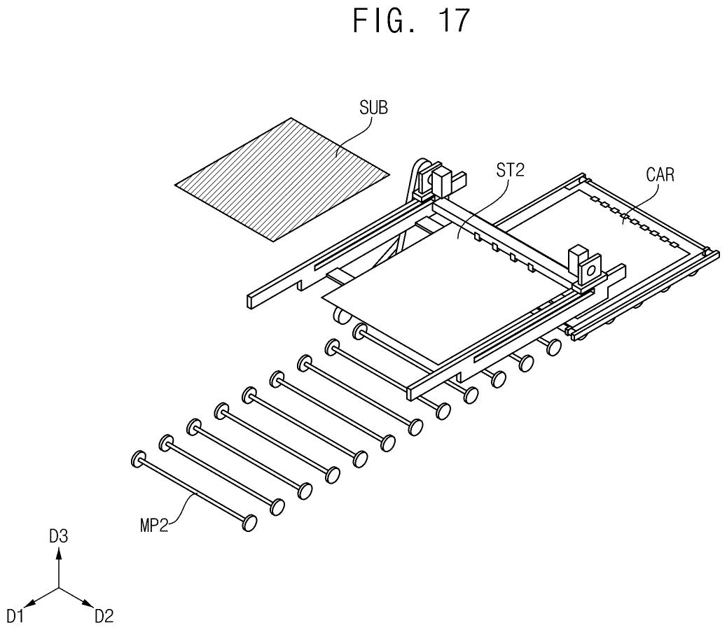

Referring further to FIGS. 1 and 17, the substrate SUB and the carrier CAR, separated from each other, may be transferred to the second load-lock chamber LC2 and the carrier storage chamber CAC, respectively. Finally, the substrate SUB that has completed the filming process may be taken out of the substrate processing apparatus SPA through the second load-lock chamber LC2 (S360).

As a result, a residence time of the substrate SUB and the carrier CAR within the coupling chamber CC may be reduced by coupling the substrate SUB and the carrier CAR as the carrier CAR moves. In addition, by separating from the substrate SUB while the carrier CAR moves, a separation time of the substrate SUB and the carrier CAR within the separation chamber SC may also be reduced, thereby increasing an overall process efficiency of the substrate processing apparatus SPA.

Embodiments of the present disclosure may be applied to a display device and an electronic device including a same. For example, the present disclosure may be applied to any of high-resolution smartphones, mobile phones, smart pads, smart watches, tablet PCs, vehicle navigation systems, televisions, computer monitors, laptops, etc.

While the disclosure has been particularly shown and described with reference to some embodiments thereof, it is to be understood by those of ordinary skill in the art that various changes in form and details may be made therein without departing from the spirit or scope of the disclosure as defined by the claims.

What is claimed is:

1. A substrate processing method comprising:
loading a substrate into a first load-lock chamber;
loading the substrate and a carrier into a coupling chamber comprising a first transferer;
seating the substrate on a first stage connected to the first transferer;
transferring the carrier in a first direction using the first transferer and coupling the carrier with the substrate seated on the first stage concurrently; and
unloading the substrate and the carrier from the coupling chamber.

2. The method of claim 1, further comprising, after seating the substrate on the first stage, rotating the first stage.

3. The method of claim 2, wherein in rotating the first stage,
the first stage is rotated such that an acute angle among inclination angles between a first base surface of a first base layer of the first stage and a first transfer surface of the first transferer is about 5 degrees to about 10 degrees.

4. The method of claim 1, further comprising, after rotating the first stage and before coupling the carrier with the substrate, transferring the substrate to a clamp portion of the carrier using a first gripper connected to the first stage.

5. The method of claim 1, wherein coupling the carrier with the substrate is performed within about two minutes.

6. The method of claim 1, wherein, in coupling the carrier with the substrate, the substrate descends along a first rotating member of the first stage.

7. The method of claim 1, wherein, in loading the carrier into the coupling chamber, a seating surface of the carrier on which the substrate is seated faces a second direction intersecting the first direction.

8. The method of claim 7, further comprising, after loading the carrier into the coupling chamber, rotating the carrier such that the seating surface of the carrier faces a third direction intersecting the first direction and the second direction.

9. The method of claim 1, further comprising, after unloading the substrate and the carrier from the coupling chamber, forming a film on the substrate using a plurality of process chambers.

10. The method of claim 9, further comprising, after forming the film on the substrate:
loading the substrate and the carrier into a separation chamber comprising a second transferer;
seating an end of the substrate on a second stage connected to the second transferer;
transferring the carrier in a direction opposite to the first direction by the second transferer, while concurrently separating the carrier from the substrate; and
unloading the substrate and the carrier from the separation chamber.

11. The method of claim 10, further comprising, after seating the end of the substrate on the second stage connected to the second transferer, seating a front surface of the substrate on the second stage using a second gripper connected to the second stage.

12. The method of claim 10, wherein, in separating the substrate and the carrier, the substrate moves up along a second rotating member of the second stage.

13. The method of claim 10, wherein separating the substrate and the carrier is performed within about two minutes.

14. The method of claim 10, further comprising, after separating the substrate and the carrier and before unloading the substrate and the carrier from the separation chamber, rotating the second stage.

15. The method of claim 14, wherein, in rotating the second stage, a second base surface of the second base layer of the second stage is rotated to be parallel to a surface of a second transfer surface of the second transferer.

16. The method of claim 10, further comprising, after separating the substrate and the carrier, rotating the carrier such that a seating surface of the carrier on which the substrate is seated faces a second direction intersecting the first direction.

17. A substrate processing apparatus comprising:
a first transferer arranged in a coupling chamber and configured to transfer a carrier in a first direction;
a first stage connected to the first transferer and rotatable around a rotation axis extending in a second direction intersecting the first direction; and
a first gripper connected to the first stage and configured to transfer the substrate in a same direction as the carrier.

18. The substrate processing apparatus of claim 17, wherein the first stage comprises a base layer and a plurality of rotation members on the base layer.

19. The substrate processing apparatus of claim 18, wherein an acute angle among inclination angles formed between a base surface of the base layer and a transfer surface of the first transferer is about 5 degrees to about 10 degrees.

20. The substrate processing apparatus of claim 17, further comprising:
a second transferer arranged in a separation chamber spaced apart from the coupling chamber and configured to transfer a carrier;
a second stage connected to the second transferer and having an inclination angle with a surface of the second transferer; and
a second gripper connected to the second stage and configured to transfer the substrate in a same direction as the carrier.
